(19) United States
(12) Patent Application Publication
(10) Pub. No.: US 2013/0289928 A1
(43) Pub. Date: Oct. 31, 2013

(54) RISK-CONTROLLED AMBIENT TEMPERATURE PROFILES

(71) Applicants: Jonathan Cherneff, Roslindale, MA (US); Paul Timothy Della Villa, Somerville, MA (US); David E. Magargee, II, jCambridge, MA (US); Mark Maurice, Bedford, MA (US); Nicole Nepomuceno, Billerica, MA (US)

(72) Inventors: Jonathan Cherneff, Roslindale, MA (US); Paul Timothy Della Villa, Somerville, MA (US); David E. Magargee, II, jCambridge, MA (US); Mark Maurice, Bedford, MA (US); Nicole Nepomuceno, Billerica, MA (US)

(73) Assignee: Carrier Corporation, Farmington, CT (US)

(21) Appl. No.: 13/996,357

(22) PCT Filed: Dec. 28, 2011
(86) PCT No.: PCT/US11/67541

§ 371 Date: Jun. 20, 2013

Related U.S. Application Data
(60) Provisional application No. 61/428,417, filed on Dec. 30, 2010.

(51) Int. Cl. G01K 3/00

(52) U.S. Cl. CPC G01K 3/00
USPC 702/130

(57) ABSTRACT

A method of generating a risk-controlled ambient temperature profile including measuring a distribution network and constructing an ambient temperature profile based on results of the measuring by determining a length of the ambient temperature profile, determining a target risk or target failure rate, and generating at least one of hot and cold versions of the ambient temperature profile in accordance with the determined length that facilitate minimization of package expense while achieving the target risk or target failure rate.

### CROSS REFERENCE TO RELATED APPLICATIONS

This application is a National Stage Application of PCT Application No. PCT/US2011/67541 filed Dec. 28, 2011, which is a PCT Application of U.S. Provisional Patent Application No. 61/428,417 filed Dec. 30, 2010, the disclosures of which are incorporated by reference herein in their entireties.

### BACKGROUND OF THE INVENTION

The subject matter disclosed herein relates to a method for creating risk-controlled ambient temperature profiles.

A key problem facing distributors of temperature sensitive products is how to manage the uncertainty of the ambient temperature of the distribution network. The ambient temperature throughout a distribution network is usually difficult to control tightly due to weather and the complexity of having multiple transport legs (truck, airplane, intermodal facilities, etc.) with corresponding transfers and perhaps involving multiple providers.

Although ambient temperature during distribution cannot be controlled, it can be measured so that the distribution of temperatures can be understood. Temperature and time are typically measured by the same logger so that the distribution of temperatures over time can be understood. Other external measurements, e.g., GPS, or other shipping waypoint logging can be correlated with temperature logs to create segmented data sets that may reveal features of transport legs that would otherwise be blurred by aggregation. Depending on the complexity of the distribution network, it is typically necessary to collect tens or hundreds of thousands of time and temperature measurements to provide definition to the temperature distributions.

This large number of temperature measurements must be reduced to one or more representative ambient temperature profiles (ATPs) in order to inform package design and to drive the test equipment used to verify the package design. That is, if an ATP of a distribution network shows that the distribution network has a certain heat load, then packaging for the temperature sensitive product can be designed with that load in mind while also taking into account package design and shipping costs. That way, if a supply of a temperature sensitive product is extremely expensive such that it is highly important to avoid exposure to extreme temperatures, package design to precisely mitigate such exposure as to be expected, as detailed in the ATP, can be accomplished even if that means utilizing an expensive package design. In many if not all cases, it is desirable to minimize the total cost of distribution comprised of package and shipping costs as well as costs of lost or quarantined product due to thermal exposure.

Problems with the methods for generating the ATPs exist, however, in that the methods often do not provide for metrics for comparing individual trip logs that are independent of package designs, they fail to control risks while minimizing package costs and they fail to provide high and low ambient temperature profiles in order to better represent hot and cold worst cases.

### BRIEF DESCRIPTION OF THE INVENTION

According to one aspect of the invention, a method of generating a risk-controlled ambient temperature profile is provided and includes measuring a distribution network and constructing an ambient temperature profile based on results of the measuring by determining a length of the ambient temperature profile, determining a target risk or target failure rate, and generating at least one of hot and cold versions of the ambient temperature profile in accordance with the determined length that facilitate minimization of package expense while achieving the target risk or target failure rate.

The method may further include designing and testing a package associated with the generated at least one of the hot and cold versions of the ambient temperature profile.

According to the method, the generating of the hot version of the ambient temperature profile may include calculating degree minutes above a target temperature.

According to the method, the generating of the hot version of the ambient temperature profile may include selecting a set of temperature loggers {L}, constructing a distribution of Q_{high} for the set {L}, letting {T} signify a set of all temperature measurements from the loggers in {L} such that each temperature measurement has a time and a temperature, bucketizing {T} by an elapsed unit of time to produce a set of buckets {Bi} and a set of sets, where i represents the elapsed unit of time and each {Bi} is a set that contains data points from many different loggers, determining ATP_length by analyzing a distribution of trip lengths, sorting each bucket {Bi} and defining {Bi}[p] to be a point having a predefined percentile p in {Bi}, choosing a high_bucket_percentile, letting {ATP_high[i], for all i} be a candidate high ambient temperature profile having temperature values for i=1 to the ATP_length such that ATP_high[i]={Bi}[high_bucket_percentile], for all i, calculating the Q_{high} value as a sum of {ATP_high[i].Q_{high}, for all i}, and calling this ATP_high.Q_{high}, and searching for the high_bucket_percentile so that ATP_high.Q_{high}=a high target for Q set in accordance with the determined target risk or target failure rate.

According to the method, the unit of time may be about one hour.

According to the method, the generating of the cold version of the ambient temperature profile may include calculating degree minutes below a target temperature.

According to the method, the generating of the cold version of the ambient temperature profile may include selecting a set of temperature loggers {L}, constructing a distribution of Q_{low} for the set {L}, letting {T} signify a set of all temperature measurements from the loggers in {L} such that each temperature measurement has a time and a temperature, bucketizing {T} by an elapsed unit of time to produce a set of buckets {Bi} and a set of sets, where i represents the elapsed unit of time and each {Bi} is a set that contains data points from many different loggers, determining ATP_length by analyzing a distribution of trip lengths, sorting each bucket {Bi} and defining {Bi}[p] to be a point having a predefined percentile p in {Bi}, choosing a low_bucket_percentile, letting {ATP_low[i], for all i} be a candidate low ambient temperature profile having temperature values for i=1 to the ATP_length such that ATP_low[i]={Bi}[high_bucket_percentile], for all i, calculating the Q_{low} value as a sum of {ATP_low[i].Q_{low}, for all i}, and calling this ATP_low.Q_{low}, and searching for the low_bucket_percentile so that ATP_low.Q_{low}=a low target for Q set in accordance with the determined target risk or target failure rate.

According to the method, the unit of time may be about one hour.

According to the method, if a result of the designing and the testing indicates that the package is undesirable, the method may further include revising the target risk or the target failure rate.

According to the method, if a result of the designing and the testing indicates that the package is excessively expensive, the method may further include revising the target risk or the target failure rate.

In accordance with another aspect of the invention, a computer readable medium is provided and has executable instructions stored thereon, which, when executed, cause a processor of a computing device to execute the methods described herein.

In accordance with another aspect of the invention, a method of generating a risk-controlled ambient temperature profile is provided and includes measuring a distribution network and constructing an ambient temperature profile based on results of the measuring by determining a length of the ambient temperature profile, determining a target risk or target failure rate, and generating a hot version or a cold version of the ambient temperature profile in accordance with the determined length that facilitates minimization of package expense while achieving the target risk or target failure rate.

The method may further include designing and testing a package associated with the generated hot version or the generated cold version of the ambient temperature profile.

In accordance with yet another aspect of the invention, a system for generating a risk-controlled ambient temperature profile is provided and includes a first means for measuring environmental conditions associated with a distribution network and a second means coupled to the first means for generating the risk-controlled ambient temperature profile by constructing an ambient temperature profile based on results of the measuring by determining a length of the ambient temperature profile, determining a target risk or target failure rate, and generating a hot version or a cold version of the ambient temperature profile in accordance with the determined length that facilitates minimization of package expense while achieving the target risk or target failure rate.

According to the system, the first means may include a set of measuring devices disposed about the distribution network.

According to the system, the second means may include a computing device.

According to the system, the second means may design and test a package associated with the generated hot version or the generated cold version of the ambient temperature profile.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a distribution network;

FIG. 2 is a graphical depiction of the relationships between shipping costs, failure costs and total shipping costs of an exemplary distribution network;

FIG. 3 is a flow diagram illustrating a method of generating a risk-controlled ambient temperature profile;

FIG. 4 is an ambient temperature log of a given exemplary trip showing heat exposure as area;

FIG. 5 is a histogram illustrating a distribution of a Q_{high} metric from a study of 645 different shipments;

FIG. 6 is a flow diagram illustrating a method of generating an ambient temperature profile of FIG. 3; and

FIGS. 7 and 8 are graphical depictions of the distribution of temperature measurements at each elapsed hour of modeled trips.

The detailed description explains embodiments of the invention, together with advantages and features, by way of example with reference to the drawings.

### DETAILED DESCRIPTION OF THE INVENTION

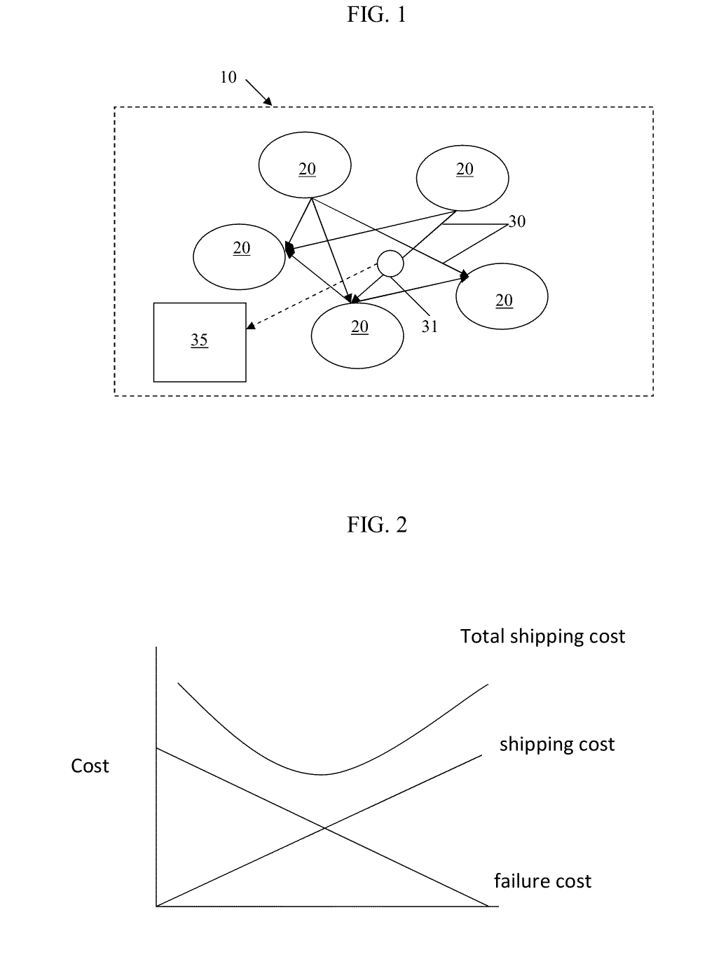

With reference to FIG. 1, a distribution network 10 is provided and includes a set of hubs 20 that are connected by shipping lanes 30 such that each pair of connected hubs 20 represents an origin-destination pair. For each origin-destination pair, the corresponding shipping lane 30 has one or more transportation modes associated with it. For example, transportation modes for a shipping lane 30 between New York City and Chicago may include trucking and rail service while transportation modes for a shipping lane 30 between New York City and Buenos Aires may include trucking, rail service, flight and sail.

In each case, the items being shipped are exposed to various environmental conditions ranging from extreme high and low temperatures to impacts in accordance with the transportation modes in effect. That is, in cases where items are shipped via trucking and rail service, impacts due to human error and local temperature increases due to weather factors may affect the items. Similarly, where items are shipped by air, similar factors exist but, in addition, temperature decreases and increases may be more pronounced if the items are shipped in an unconditioned cargo hold of the plane. Measurement of these environmental conditions may be provided by way of, for example, thermocouples 31 for temperature measurements that communicate with a central computing device 35.

Thus, it is frequently necessary to ship the items in containers that are able to insulate the items from temperature increases and decreases and that provide thermal buffers, typically in the form of phase change materials (PCM) or other similar materials, which are able to withstand thermal changes and physical impacts to protect the items. As these containers are provided with increased insulation and protection, however, they become more and more expensive. Such added expense may be helpful in the shipping of very expensive and fragile items, such as vaccines, but is of little utility otherwise especially where a primary goal of shipping is to minimize costs. This is shown schematically in FIG. 2, in which it is illustrated that as shipping costs increase, failure costs tend to decrease and vice versa but that total shipping costs, which take into account shipping costs and the failure costs can be minimized.

As such, while it may be advantageous to use highly insulating, protective and expensive containers for expensive items it is similarly advantageous to use less expensive containers for less expensive items. However, although expensive containers can decrease failure costs for a given set of items being shipped, if it is determined that those items will be shipped in manner that is unlikely to lead to failures, the need for such expensive containers is decreased if total shipping costs are to be minimized. Thus, in accordance with aspects of the invention, ambient temperature profiles that provide a generalization of shipping instances (hereinafter referred to as “trips”) will be generated from the measurements provided by the thermocouples 31 that are substantially independent of a type of a container being used so that, once each trip is modeled by central computing device 35, a design decision for the corresponding container can be made at a later operational time.

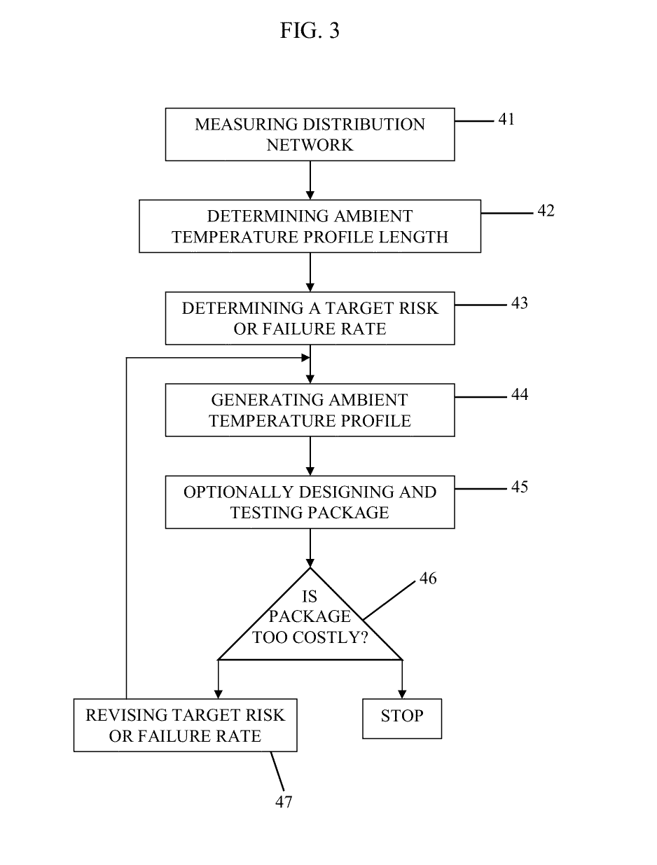

With reference to FIG. 3, a method of generating risk-controlled ambient temperature profiles is provided. The method includes measuring a distribution network 41, determining an ambient temperature profile length 42 and a target risk or failure rate 43, generating an ambient temperature profile 44 in accordance with, at least, the ambient temperature profile length and, optionally, designing and testing a package 45 in accordance with the ambient temperature profile and the target risk or failure rate. If it is then determined that the package design is too costly, at operation 46, the method may further include revising the risk level 47 and repeating operations 44-46, as needed.

In order to accomplish at least operation 43 and operation 44, it will be necessary to make comparisons of various trips and, to do so, metrics are required that will, to a reasonable approximation, allow for comparisons of two or more ambient temperature logs or for comparisons of trips to ambient temperature profiles.

$$\begin{matrix}\frac{d Δ T}{d t} - k Δ T & Eq 1 \\ q = K Δ T & Eq 2\end{matrix}$$

Newton's Law of Heat Transfer, as provided in Equation 1, states that the rate of change of temperature in a system is proportional to the temperature difference within the system. From this statement, it can be derived that heat flow, q, is also proportional to temperature difference, as stated in Equation 2. Since, this discussion concerns insulated, sealed packages, this model can be relied upon for a reasonable approximation.

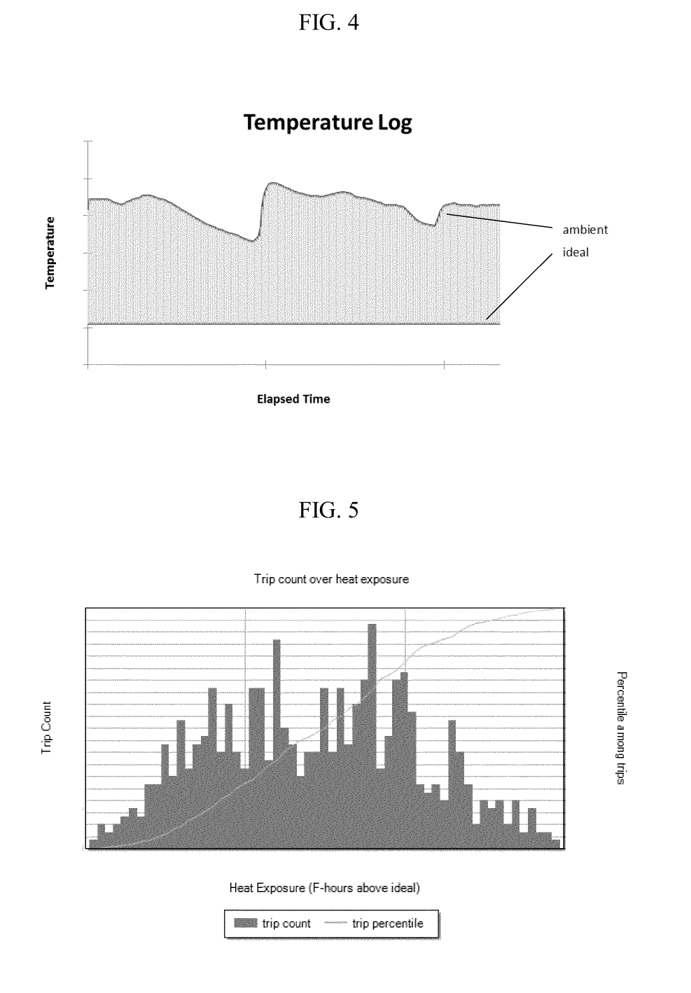

With reference to FIG. 4, an ambient temperature log of a given, exemplary trip is provided. The top line shows that ambient temperature varies over time and the bottom line represents a desired product temperature, which is constant. If it is assumed that whatever box is used succeeds in keeping the product approximately at its desired temperature, then the difference between the top line and the bottom line at any point is proportional to q, the rate of heat transfer at that time. The shaded area between the lines represents the total heat flow Q which is proportional to the sum over time of the temperature difference between ambient and internal temperature. That is:

$$Q = {\sum }_{t}^{ } q = K {\sum }_{t}^{ } Δ T \qquad Eq 3$$

The constant K depends on the insulation of the package, which is not known before the package is designed and, in many cases, typical packaging may also have phase change material (PCM) or other similar materials, which can be assumed to be at equilibrium with the product at approximately the desired product temperature. A problem with Equation 3 is that it allows positive and negative heat flows to cancel each other. To eliminate this effect, positive and negative flows are treated separately, as in:

$${Q}_{high} = {\sum }_{t}^{ } max ( q , 0 ) \\ {Q}_{low} = {\sum }_{t}^{ } min ( q , 0 ) \qquad Eq 4$$

Equation 4 allows for a comparison of different temperature logs according to high and low heat loads they present without knowing the design or behavior of the package.

The histogram shown in FIG. 5 illustrates an exemplary distribution of the Q_{high} metric from a study of 645 different possible shipments, where each shipment has one temperature logger. The thin line shows the percentile of each histogram bucket in the total population, for example, trips having a Q_{high}=1040 are at the 73^{rd} percentile among the overall population. A separate graph would be constructed for the metric Q_{low} for the same set of 645 trips. The total number of trips and the selection of trips must be carefully designed to provide an adequate and representative sample of the corresponding distribution network.

When the ambient temperature profile is constructed, the resulting Q_{high} metric, ATP_{—high.Q}_{high}, can be calculated and compared to the Q_{high} distribution described in FIG. 5. The percentile of the value of ATP_{—high.Q}_{high} among the Q_{high} distribution described in FIG. 5 is an indicator of the probability that the heat load of a future real trip would exceed the heat load of the proposed ambient temperature profile. Based on factors such as risk aversion and product stability, the user can pick a target Q_{high} and then design the ATP to achieve the target Q_{high}.

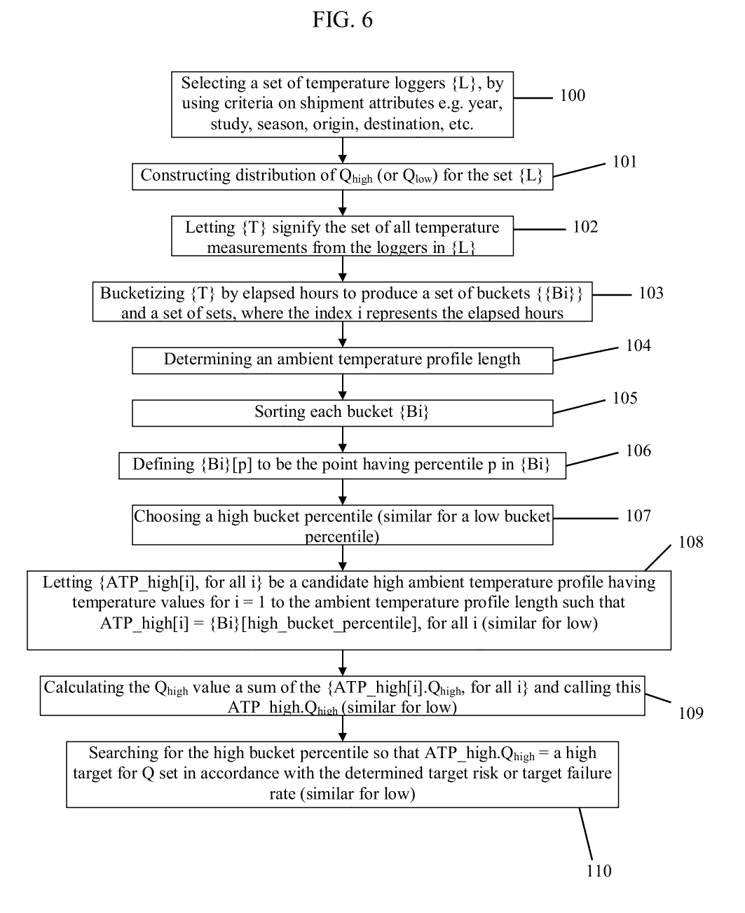

With the above in mind, and with reference back to operations 42-44 of FIG. 3, further operations to construct the ambient temperature profile are shown in FIG. 6. These operations include selecting a set of temperature loggers {L}, by using criteria on shipment attributes e.g. year, study, season, origin, destination, etc., at operation 100. For operation 100, use of disparate shipping lanes should be avoided, lane groupings should be relevant to customer supply chain considerations and sample sizes should be sufficient as determined on case by case basis with historical data used as reference. Next, a distribution of Q_{high} (or Q_{low}) is constructed for the set {L} at operation 101. At this point, the method includes letting {T} signify the set of all temperature measurements from the loggers in {L}, at operation 102, such that each temperature measurement has a time and a temperature, and bucketizing {T} by elapsed hours (or seconds, minutes, sets of minutes, days, etc.) to produce a set of buckets Bi, and a set of sets {{Bi}}, where the index i represents the elapsed hours, at operation 103. Here, each {Bi} is a set that contains data points from many different loggers and the term “bucketizing” refers to an organization of data points into discrete sets or “buckets.”

From here, the method includes determining an ambient temperature profile length by analyzing the distribution of trip lengths where trip length would be the elapsed time of the last relevant data point on the logger at operation 104, sorting each bucket {Bi} at operation 105, and defining {Bi}[p] to be the point having percentile p in {Bi} at operation 106, so that, for example, {Bi}[100]=max{Bi}; {Bi}[90]=90^{th} percentile point in {Bi}. Since not all values of p are represented in {Bi}, by {Bi}[90], this means the point in {Bi} whose percentile is closest to 90.

Finally, the method includes choosing a high bucket percentile (similarly for a low bucket percentile) at operation 107, letting {ATP_high[i], for all i} be a candidate high ambient temperature profile having temperature values for i=1 to the ambient temperature profile length, such that the ATP_high[i]={Bi}[high bucket percentile], for all i, at operation 108, calculating the Q_{high} value as a sum of the {ATP_{—high[i].Q}_{high}, for all i} and calling this ATP_{—high.Q}_{high} at operation 109 and searching for the high bucket percentile (similarly for low bucket percentile) at operation 110 so that

ATP_{high.}Q_{high}≈Q_{high}_{_{—}}_{target}

where the Q_{high}_{_{—}}_{target} is set in accordance with the determined target risk or failure rate of operation 43.

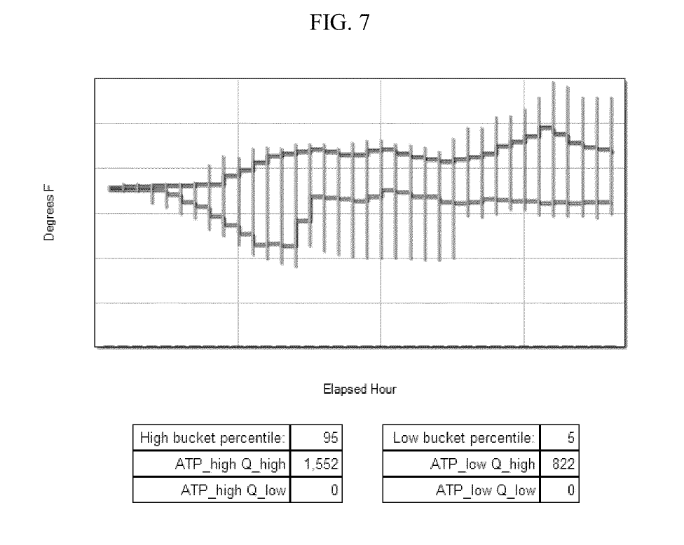

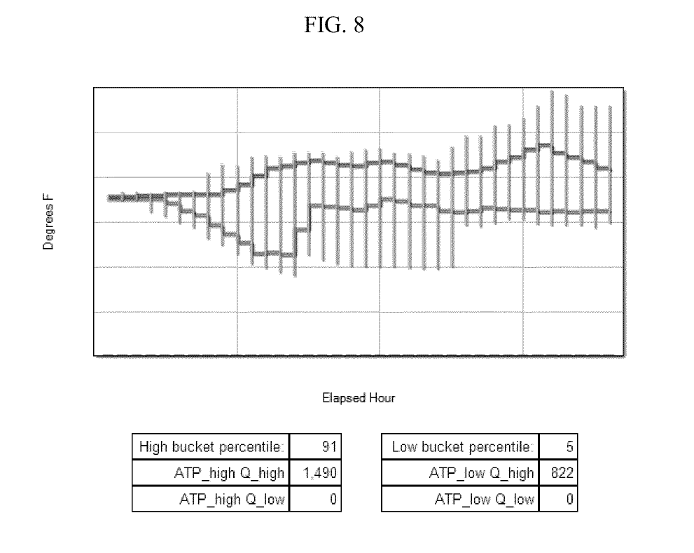

With reference to FIGS. 7 and 8, based on the above derivations, as shown in FIG. 7, the ATP_{—high.Q}_{high} value=1552 for the exemplary choice of high bucket percentile=95. Referring back to the histogram of FIG. 5, it is noted that a highest total heat value may be measured at 1490, however, so search might proceed by reducing the high bucket percentile. Thus, FIG. 8 shows the result for trying high bucket percentile=91. The search proceeds using a “generate and test” paradigm: the user generates a high bucket percentile and the computer code tests this value by producing results like those shown in FIG. 8.

In accordance with aspects of the invention, the methods described above may be embodied as a computer readable medium having executable instructions stored thereon, which, when executed, cause a processor of, for example, the computing device 35 of FIG. 1 to execute the methods.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method of generating a risk-controlled ambient temperature profile, comprising:
measuring a distribution network; and
constructing an ambient temperature profile based on results of the measuring by:
determining a length of the ambient temperature profile, determining a target risk or target failure rate, and
generating at least one of hot and cold versions of the ambient temperature profile in accordance with the determined length that facilitate minimization of package expense while achieving the target risk or target failure rate.

2. The method according to claim 1, further comprising designing and testing a package associated with the generated at least one of the hot and cold versions of the ambient temperature profile.

3. The method according to claim 1, wherein the generating of the hot version of the ambient temperature profile comprises calculating degree minutes above a target temperature.

4. The method according to claim 1, wherein the generating of the hot version of the ambient temperature profile comprises:
selecting a set of temperature loggers {L};
constructing a distribution of Q_{high} for the set {L};
letting {T} signify a set of all temperature measurements from the loggers in {L} such that each temperature measurement has a time and a temperature;
bucketizing {T} by an elapsed unit of time to produce a set of buckets {Bi} and a set of sets, where i represents the elapsed unit of time and each {Bi} is a set that contains data points from many different loggers;
determining ATP_length by analyzing a distribution of trip lengths;
sorting each bucket {Bi} and defining {Bi}[p] to be a point having a predefined percentile p in {Bi};
choosing a high_bucket_percentile;
letting {ATP_high[i], for all i} be a candidate high ambient temperature profile having temperature values for i=1 to the ATP_length such that ATP_high[i]={Bi}[high_bucket_percentile], for all i;
calculating the Q_{high} value as a sum of {ATP_high[i].Q_{high}, for all i} and calling this ATP_high.Q_{high}; and
searching for the high_bucket_percentile so that ATP_high.Q_{high}=a high target for Q set in accordance with the determined target risk or target failure rate.

5. The method according to claim 4, wherein the unit of time is about one hour.

6. The method according to claim 1, wherein the generating of the cold version of the ambient temperature profile comprises calculating degree minutes below a target temperature.

7. The method according to claim 1, wherein the generating of the cold version of the ambient temperature profile comprises:
selecting a set of temperature loggers {L};
constructing a distribution of Q_{low} for the set {L};
letting {T} signify a set of all temperature measurements from the loggers in {L} such that each temperature measurement has a time and a temperature;
bucketizing {T} by an elapsed unit of time to produce a set of buckets {Bi} and a set of sets, where i represents the elapsed unit of time and each {Bi} is a set that contains data points from many different loggers;
determining ATP_length by analyzing a distribution of trip lengths;
sorting each bucket {Bi} and defining {Bi}[p] to be a point having a predefined percentile p in {Bi};
choosing a low_bucket_percentile;
letting {ATP_low[i], for all i} be a candidate low ambient temperature profile having temperature values for i=1 to the ATP_length such that ATP_low[i]={Bi}[high_bucket_percentile], for all i;
calculating the Q_{low} value as a sum of {ATP_low[i].Q_{low}, for all i} and calling this ATP_low.Q_{low}; and
searching for the low_bucket_percentile so that ATP_low.Q_{low}=a low target for Q set in accordance with the determined target risk or target failure rate.

8. The method according to claim 7, wherein the unit of time is about one hour.

9. The method according to claim 1, wherein, if a result of the designing and the testing indicates that the package is undesirable, the method further comprises revising the target risk or the target failure rate.

10. The method according to claim 1, wherein if a result of the designing and the testing indicates that the package is excessively expensive, the method further comprises revising the target risk or the target failure rate.

11. A computer readable medium having executable instructions stored thereon, which, when executed, cause a processor of a computing device to execute the method of claim 1.

12. A method of generating a risk-controlled ambient temperature profile, comprising:
measuring a distribution network; and
constructing an ambient temperature profile based on results of the measuring by:
determining a length of the ambient temperature profile,
determining a target risk or target failure rate, and
generating a hot version or a cold version of the ambient temperature profile in accordance with the determined length that facilitates minimization of package expense while achieving the target risk or target failure rate.

13. The method according to claim 12, further comprising designing and testing a package associated with the generated hot version or the generated cold version of the ambient temperature profile.

14. A system for generating a risk-controlled ambient temperature profile, the system comprising:
a first means for measuring environmental conditions associated with a distribution network; and
a second means coupled to the first means for generating the risk-controlled ambient temperature profile by constructing an ambient temperature profile based on results of the measuring by:
determining a length of the ambient temperature profile,
determining a target risk or target failure rate, and
generating a hot version or a cold version of the ambient temperature profile in accordance with the determined length that facilitates minimization of package expense while achieving the target risk or target failure rate.

15. The system according to claim 14, wherein the first means comprises a set of measuring devices disposed about the distribution network.

16. The system according to claim 14, wherein the second means comprises a computing device.

17. The system according to claim 14, wherein the second means designs and tests a package associated with the generated hot version or the generated cold version of the ambient temperature profile.
